(19) United States
(12) Patent Application Publication
(10) Pub. No.: US 2013/0342193 A1
(43) Pub. Date: Dec. 26, 2013

(54) SENSOR FOR DIGITIZER AND METHOD OF MANUFACTURING THE SAME

(71) Applicant: SAMSUNG ELECTRO-MECHANICS CO., LTD., Gyunggi-do (KR)

(72) Inventors: Dong Sik Yoo, Gyunggi-do (KR); Hee Bum Lee, Gyunggi-do (KR); Ho Yun Cho, Gyunggi-do (KR); Yun Ki Hong, Gyunggi-do (KR); Kyoung Soo Chae, Gyunggi-do (KR)

(73) Assignee: SAMSUNG ELECTRO-MECHANICS CO., LTD., Gyunggi-do (KR)

(21) Appl. No.: 13/666,335

(22) Filed: Nov. 1, 2012

(30) Foreign Application Priority Data
Jun. 22, 2012 (KR) 10-2012-0067457

(51) Int. Cl. G01N 27/72; H01F 41/04

(52) U.S. Cl. 324/228; 427/131

(57) ABSTRACT

Disclosed herein are a sensor for a digitizer and a method of manufacturing the same. The sensor includes a magnetic layer having insulation; a first coil embedded in the magnetic layer; a second coil formed on one surface of the magnetic layer; and an insulating layer formed on one surface of the magnetic layer to cover the second coil. Thus, since the first coil and the second coil are formed on the magnetic layer formed of a magnetic material, a magnetic field is stably formed between coils and stability of signals transmitted and received between a coil and an input device is increased.

### CROSS REFERENCE TO RELATED APPLICATION

This application claims the benefit of Korean Patent Application No. 10-2012-0067457, filed on Jun. 22, 2012, entitled “Sensor for Digitizer and Method of Manufacturing the Same”, which is hereby incorporated by reference in its entirety into this application.

### BACKGROUND OF THE INVENTION

1. Technical Field

The present invention relates to a sensor for a digitizer and a method of manufacturing the same.

2. Description of the Related Art

As computers using digital technologies have been developed, auxiliary equipment of computers has been developed together. A personal computer, a portable transmitting apparatus, or other personal information processing apparatuses perform text and graphic processes by using various input devices such as a keyboard, mouse, and the like.

However, along with the rapid development of information-oriented society, computers have been widely used, and thus, it is difficult to effectively drive a product by using only a keyboard and a mouse, which presently function as an input device. Accordingly, there is an increasing need for a device to which anyone can easily input information via a simple method without miss handling.

Technologies for input devices have exceeded the standard for obtaining general functions and interest in technologies for input devices has changed toward high reliability, high durability, high innovation, design, and process-related technologies. To this end, an electromagnetic wave induction-type digitizer has been developed as an input device for inputting information such as text, graphic, and so on.

Currently, a capacitive touch screen has been used as an input device for performing a similar function to an electromagnetic wave induction-type digitizer. However, the capacitive touch screen cannot correctly detect a pen pressure as well as coordinates, compared with an electromagnetic wave induction-type digitizer. Thus, an electromagnetic wave induction-type digitizer is more advantageous than a capacitive touch screen in terms of precision or accuracy.

An example of a conventional digitizer is disclosed in the description of the related art of Korean Patent No. 10-0510729.

In Korean Patent No. 10-0510729, the digitizer includes a sensor and a controller, in which the sensor is disposed below a liquid crystal panel and transmits and receives electromagnetic waves that resonate at a point which is touched with an electronic pen in order to recognize a touch position, and the controller controls the sensor.

In this case, the sensor includes a sensor printed circuit board (PCB) and a plurality of X-axis coils and Y-axis coils that are formed on the sensor PCB.

In addition, the controller is disposed below the sensor and includes a control processor unit (CPU) that transmits a signal to the sensor and reads a signal that is input back to the CPU to detect a position of the electronic pen.

In addition, a resonance circuit including a coil and a condenser is installed in the electronic pen.

The conventional digitizer is configured in such a way that the sensor operates according to a signal received from the controller and selects an X-axis and Y-axis coils to generate electromagnetic waves while inducing electromagnetism. The electronic pen resonates due to the generated electromagnetic waves. A resonance frequency is received by the sensor while being held for a predetermined period of time. The controller reads the signal received by the sensor to detect a touch position.

With regard to a digitizer, there is a need to increase stability of signals, for example, signals transmitted and received between coils, which do not attenuate due to the influence of peripheral devices. However, the above-described digitizer does not include a separate component for satisfying these requirements.

### SUMMARY OF THE INVENTION

The present invention has been made in an effort to provide a sensor for a digitizer for increasing stability of signals transmitted and received by the sensor, and a method of manufacturing the sensor.

According to a first preferred embodiment of the present invention, there is provided a sensor for a digitizer, including: a magnetic layer having insulation; a first coil embedded in the magnetic layer; a second coil formed on one surface of the magnetic layer; and an insulating layer formed on one surface of the magnetic layer to cover the second coil.

The magnetic layer of the sensor may be formed of an oxide magnetic material including at least two elements selected from the group consisting of iron (Fe), nickel (Ni), zinc (Zn), manganese (Mn), magnesium (Mg), cobalt (Co), barium (Ba), and strontium (Sr).

The insulating layer of the sensor may be a magnetic layer having insulation.

The insulation layer of the sensor may be formed of an oxide magnetic material including at least two elements selected from the group consisting of Fe, Ni, Zn, Mn, Mg, Co, Ba, and Sr.

The sensor may further include a power coil formed on one surface of the magnetic layer.

The sensor may further include an electromagnetic wave shielding layer formed on the other surface of the magnetic layer.

The electromagnetic wave shielding layer of the sensor may include an electromagnetic wave absorbing material and a heat dissipation material.

The electromagnetic wave shielding layer of the sensor may be adhered to the other surface of the magnetic layer via adhesives.

According to a second preferred embodiment of the present invention, there is provided a method of manufacturing a sensor for a digitizer, including: forming a lower magnetic layer having insulation on one surface of a base film; forming a first coil on one surface of the lower magnetic layer; forming an upper magnetic layer on one surface of the lower magnetic layer such that the first coil is embedded in the upper magnetic layer; forming a second coil on one surface of the upper magnetic layer; and forming an insulating layer on one surface of the upper magnetic layer so as to cover the second coil.

The method may further include, after the forming of the lower magnetic layer, delaminating the base film from the lower magnetic layer.

The method may further include, after the delaminating of the base film from the lower magnetic layer, forming an electromagnetic wave shielding layer on the other surface of the lower magnetic layer.

In the method, the electromagnetic wave shielding layer may include an electromagnetic wave absorbing material and a heat dissipation material.

In the method, the upper magnetic layer and the lower magnetic layer may be formed of an oxide magnetic material including at least two elements selected from the group consisting of Fe, Ni, Zn, Mn, Mg, Co, Ba, and Sr.

In the method, the insulating layer may be a magnetic layer having insulation.

In the method, the insulation layer may be formed of an oxide magnetic material including at least two elements selected from the group consisting of Fe, Ni, Zn, Mn, Mg, Co, Ba, and Sr.

In the method, the forming of the second coil may include forming a power coil on one surface of the upper magnetic layer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a sensor for a digitizer according to an embodiment of the present invention;

FIGS. 2 through 6 are cross-sectional views for explaining a method of manufacturing the sensor shown in FIG. 1, according to an embodiment of the present invention; and

FIG. 7 is a cross-sectional view of a sensor for a digitizer, which is obtained by further including an electromagnetic wave shielding layer to the sensor shown in FIG. 1, according to another embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a sensor for a digitizer and a method of manufacturing the same will be described with reference to the attached drawings.

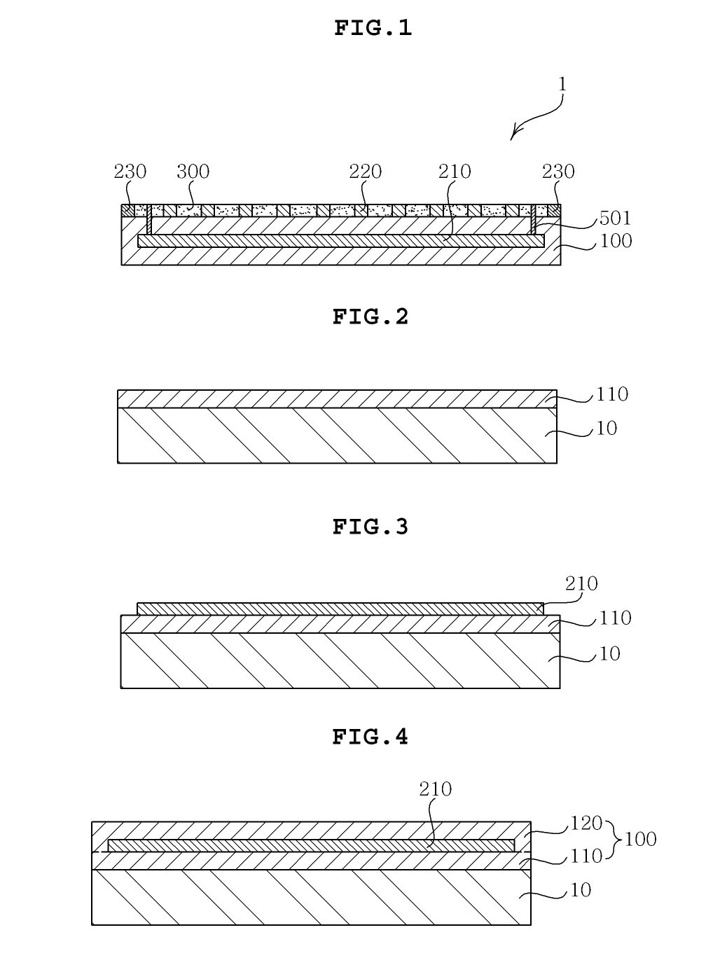

FIG. 1 is a cross-sectional view of a sensor 1 for a digitizer according to an embodiment of the present invention. FIGS. 2 through 6 are cross-sectional views for explaining a method of manufacturing the sensor 1 shown in FIG. 1, according to an embodiment of the present invention. FIG. 7 is a cross-sectional view of a sensor 1 for a digitizer, which is obtained by further including an electromagnetic wave shielding layer 400 to the sensor 1 shown in FIG. 1, according to another embodiment of the present invention.

As shown in FIG. 1, the sensor 1 according to the present embodiment includes a magnetic layer 100 having insulation, a first coil 210 that is embedded in the magnetic layer 100, a second coil 220 formed in a surface of the magnetic layer 100, and an insulating layer 300 formed on the surface of the magnetic layer 100 to cover the second coil 220.

Unlike a conventional sensor for a digitizer, the first coil 210 and the second coil 220, which are described below, are formed on the magnetic layer 100 formed of a magnetic material in order to further increase stability of signals transmitted and received between a coil and a resonance circuit of an input device (not shown) such as an electronic pen.

For example, the magnetic layer 100 may be formed of an oxide magnetic material including at least two elements selected from the group consisting of iron (Fe), nickel (Ni), zinc (Zn), manganese (Mn), magnesium (Mg), cobalt (Co), barium (Ba), and strontium (Sr).

Since the magnetic layer 100 is formed of the above materials, the magnetic layer 100 may have high resistivity to have insulation. The magnetic layer 100 has insulation in order to have sufficient insulation between lines adjacent to the first coil 210 formed on the magnetic layer 100 and described below.

The first coil 210 and the second coil 220 are components for detecting a touch position of an input device.

First, a resonance circuit including an inductor and a capacitor may be installed in the input device. The resonance circuit of the input device resonates due to an electromagnetic force input from an external source. The resonance circuit may resonate to generate induced current. Energy due to the generated induced current may be stored in the capacitor.

In addition, when the electromagnetic force is no longer supplied from the external source, the capacitor of the input device resonates with the inductor due to the energy stored in the capacitor. During this process, an electromagnetic force is emitted.

The first coil 210 may be embedded in the magnetic layer 100. In this case, a plurality of first coils 210 may be formed to each have a loop shape with a longitudinal direction as one direction and may be arranged in parallel to each other in the other direction.

The second coil 220 may be formed on one surface of the magnetic layer 100. In this case, a plurality of second coils 220 may be formed to each have a loop shape with a longitudinal direction that is perpendicular to the first coils 210 to cross the first coils 210 and may be arranged in parallel to each other in one direction.

Intersections between the first coils 210 and the second coils 220 may be detection regions for detecting a touch position of the input device.

Any one of the first coil 210 and the second coil 220 may be used as a driving coil receiving current from a controller. In addition, the other one of the first coil 210 and the second coil 220 may be a detection coil that generates voltage due to magnetic field lines induced from the driving coil. The voltage (induced electromotive force) induced from the detection coil is proportionate to a variation of the magnetic field lines induced from the driving coil according to time. Thus, the magnetic field lines induced from the driving coil need to be periodically changed so as to induce voltage in the detection coil. In the end, the driving coil receives alternating current (AC) from the controller such that the induced magnetic field lines may be periodically changed.

The first coil 210 and the second coil 220 may be controlled by the controller to have voltage. In this case, when the input device approaches the first coil 210 and the second coil 220, the first coil 210 and the second coil 220 are affected by the electromagnetic force emitted from the input device to generate a voltage difference between the first coil 210 and the second coil 220. The controller recognizes the voltage difference to check a touch position of the input device.

The first coil 210 is embedded in the magnetic layer 100. Since the magnetic layer 100 has insulation as described above, the first coil 210 is insulated from coils adjacent to the first coil 210.

The second coil 220 is formed on one surface of the magnetic layer 100. The insulating layer 300 may be formed on one surface of the magnetic layer 100 such that the second coil 220 is also insulated from other coils.

The insulating layer 300 may be formed of various materials having insulation. In this case, the insulating layer 300 may be formed of the same material as the magnetic layer 100. That is, the insulating layer 300 may be formed of an oxide magnetic material including at least two elements selected from the group consisting of Fe, Ni, Zn, Mn, Mg, Co, Ba, and Sr.

According to the present embodiment, since the insulating layer 300 is formed of an oxide magnetic material like the magnetic layer 100, both the first coil 210 and the second coil 220 may be embedded in the magnetic layer 100 formed of a magnetic material.

A power coil 230 may be formed on one surface of the magnetic layer 100.

Although an input device may be configured in such a way that the resonance circuit resonates due to AC power received from an external source, the input device may be configured as a powerless input device that resonates due to an electromagnetic force received from an external source, as described above.

According to the present embodiment, in order to input an electromagnetic force to a resonance circuit of the powerless input device, the power coil 230 may be formed on one surface of the magnetic layer 100. In detail, the power coil 230 is separately controlled from the first coil 210 and the second coil 220 by the controller. The controller may control power supply to supply driving power to the power coil 230 during a period of time when power is supplied to the input device. When an electromagnetic force is emitted due to the power supplied to the power coil 230, the resonance circuit of the input device may store an electromagnetic force input thereto.

In addition, the controller may stop supplying power to the power coil 230 during a period of time for detecting a touch position of the input device. In this case, the input device may emit an electromagnetic force due to energy stored in the input device. The emitted electromagnetic force generates a voltage difference between the first coil 210 and the second coil 220.

A method of manufacturing a sensor for a digitizer according to an embodiment of the present invention will now be described with reference to FIGS. 2 through 6.

The method of manufacturing the sensor includes (a) forming a lower magnetic layer 110 having insulation on one surface of a base film 10, (b) forming the first coil 210 on one surface of the lower magnetic layer 110, (c) forming an upper magnetic layer 120 on one surface of the lower magnetic layer 110 such that the first coil 210 is embedded in the upper magnetic layer 120, (d) forming the second coil 220 on one surface of the upper magnetic layer 120, and (e) forming the insulating layer 300 on one surface of the upper magnetic layer 120 to cover the second coil 220.

In operation (a), the lower magnetic layer 110 is formed on one surface of the base film 10, as shown in FIG. 2. An example of the base film 10 may include a polyethylene terephthalate (PET) film. In addition, the lower magnetic layer 110 may be formed of an oxide magnetic material including at least two elements selected from the group consisting of Fe, Ni, Zn, Mn, Mg, Co, Ba, and Sr.

For example, the lower magnetic layer 110 may be formed on one surface of the base film 10 by mixing a polymer binder and powders that are materials of the lower magnetic layer 110, coating the mixed materials on the base film 10, and hot-pressing the mixed materials via rolling, casting, or the like. However, a method of forming the lower magnetic layer 110 on the base film 10 is not limited to the above-described method. The lower magnetic layer 110 may be formed on one surface of the base film 10 by using other various methods, for example, a method including forming a reaction solution including an oxygen solution and metallic elements, which are materials for forming the lower magnetic layer 110, in the form of droplets and coating the reaction solution via a spraying method.

In operation (b), the first coil 210 is formed on one surface of the lower magnetic layer 110, as shown in FIG. 3. The first coil 210 may be formed on the lower magnetic layer 110 by using various methods such as plating, vapor deposition, or the like. In addition, the first coil 210 may be formed in the form of loop on the lower magnetic layer 110. In this case, a plurality of first coils 210 may be connected in parallel to each other.

In operation (c), the upper magnetic layer 120 is formed on one surface of the lower magnetic layer 110 such that the first coil 210 is embedded in the upper magnetic layer 120, as shown in FIG. 4.

Like the lower magnetic layer 110, the upper magnetic layer 120 may be formed of an oxide magnetic material including at least two elements selected from the group consisting of Fe, Ni, Zn, Mn, Mg, Co, Ba, and Sr. In addition, the upper magnetic layer 120 may be formed on one surface of the lower magnetic layer 110 by using the same method as the method of forming the lower magnetic layer 110.

The first coil 210 may be completely embedded in the upper magnetic layer 120 and the lower magnetic layer 110 as the upper magnetic layer 120 is formed. In addition, the above-described materials for forming the upper magnetic layer 120 and the lower magnetic layer 110 have high resistivity to have insulation. Thus, the first coil 210 that is embedded in the upper magnetic layer 120 and the lower magnetic layer 110 is electrically insulated from lines adjacent to the first coil 210.

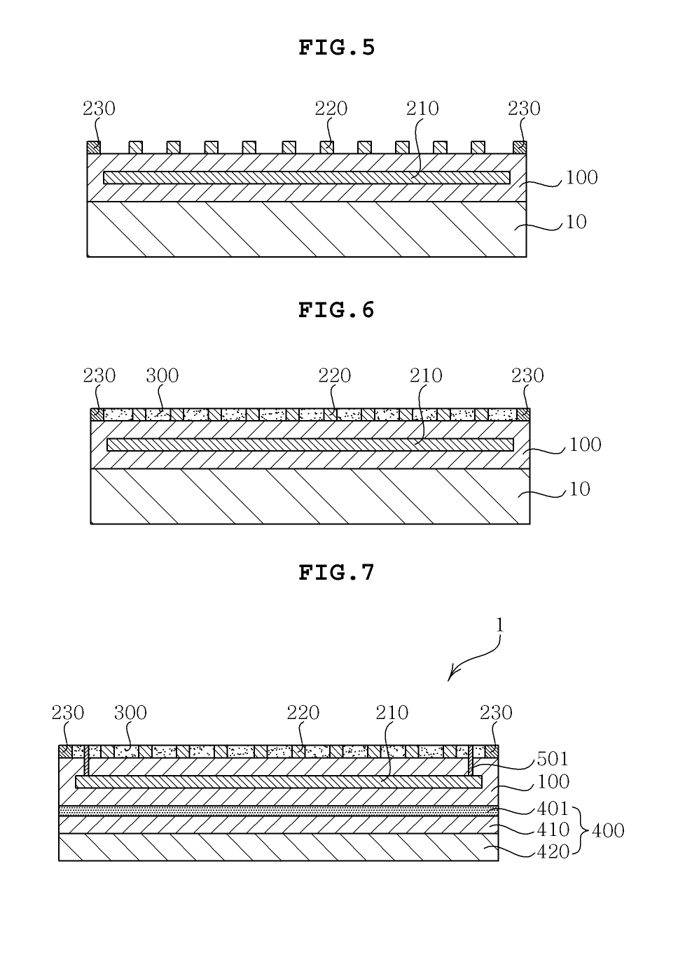

In operation (d), the second coil 220 is formed on one surface of the upper magnetic layer 120, as shown in FIG. 5. Like the first coil 210, the second coil 220 may be formed on the upper magnetic layer 120 by using various methods such as plating, vapor deposition, or the like. Like the first coil 210, the second coil 220 may be formed in the form of loop. In this case, a plurality of second coils 220 may be formed to each have a longitudinal direction that crosses the first coils 210 and may be connected in parallel to each other.

In addition, operation (d) may further include forming the power coil 230 together with the second coil 220 on one surface of the upper magnetic layer 120. The power coil 230 may also be formed in the shape of a loop. In addition, the power coil 230 may be formed along an edge region of the upper magnetic layer 120 so as not to overlap an interaction between the first coil 210 and the second coil 220, which constitutes a region, as shown in FIG. 5.

In operation (e), the insulating layer 300 is formed on one surface of the upper magnetic layer 120 so as to cover the second coil 220, as shown in FIG. 6. The insulating layer 300 is formed to electrically insulate lines adjacent to the second coil 220 from each other. The insulating layer 300 may be formed of various materials having insulation. The insulating layer 300 may be formed of the same material as the upper magnetic layer 120 and the lower magnetic layer 110. That is, the insulating layer 300 may be formed of an oxide magnetic material including at least two elements selected from the group consisting of Fe, Ni, Zn, Mn, Mg, Co, Ba, and Sr. This is because these materials also have high resistivity to have insulation.

The base film 10 prepared in operation (a) may be removed by delaminating the base film 10 after operation (a) is performed. FIG. 1 shows a state when the base film 10 is removed. The base film 10 may be delaminated just after operation (a) is performed, or alternatively, may be delaminated after any one of operations (b) to (e) is performed.

According to the present embodiment, as shown in FIG. 7, the manufacturing method may further include forming the electromagnetic wave shielding layer 400 after the base film 10 is delaminated.

The electromagnetic wave shielding layer 400 may prevent electromagnetic waves generated between the first and second coils 210 and 220 and the input device from leaking outside the sensor 1 such that the electromagnetic waves may not affect other devices disposed outside the sensor 1 and may also prevent electromagnetic waves generated from an external source from affecting the sensor 1.

In detail, the electromagnetic wave shielding layer 400 may include a heat dissipation material and an electromagnetic wave absorbing material. An example of the heat dissipation material may include alumina or aluminum nitride. In addition, an example of the electromagnetic wave absorbing material may include ferrite or sendust.

Since the electromagnetic wave shielding layer 400 includes these materials, the electromagnetic wave shielding layer 400 may effectively prevent electromagnetic waves from being introduced into the sensor 1 and leaking outside the sensor 1. In addition, the electromagnetic wave shielding layer 400 may have a heat dissipation structure that may effectively dissipate heat generated during an absorbing process of electromagnetic waves.

Although the electromagnetic wave shielding layer 400 may be formed as a single layer in which the above-described materials are mixed together, the electromagnetic wave shielding layer 400 may have a stack structure including a heat dissipation layer 410 formed of a heat dissipating material and an electromagnetic wave absorbing layer 420 including electromagnetic wave absorbing material, which are different layers, as shown in FIG. 7.

The electromagnetic wave shielding layer 400 may be formed on the other surface of the lower magnetic layer 110 by adhering the electromagnetic wave shielding layer 400 to the other surface of the lower magnetic layer 110 via adhesives 401.

Reference numeral 501 of FIGS. 1 and 7 denotes a via hole. The via hole 501 is formed to connect the first coil 210 to a flexible printed circuit board (FPCB) (not shown) disposed outside the sensor 1. The via hole 501 may be formed to be connected to the first coil 210 through the insulating layer 300.

As described above, since the first coil 210 and the second coil 220 are formed on the magnetic layer 100 formed of a magnetic material, a magnetic field may be stably formed between coils and stability of signals transmitted and received between a coil and an input device may be increased.

Although the embodiments of the present invention have been disclosed for illustrative purposes, it will be appreciated that the present invention is not limited thereto, and those skilled in the art will appreciate that various modifications, additions, and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A sensor for a digitizer, comprising:
a magnetic layer having insulation;
a first coil embedded in the magnetic layer;
a second coil formed on one surface of the magnetic layer; and
an insulating layer formed on one surface of the magnetic layer to cover the second coil.

2. The sensor as set forth in claim 1, wherein the magnetic layer is formed of an oxide magnetic material comprising at least two elements selected from the group consisting of iron (Fe), nickel (Ni), zinc (Zn), manganese (Mn), magnesium (Mg), cobalt (Co), barium (Ba), and strontium (Sr).

3. The sensor as set forth in claim 1, wherein the insulating layer is a magnetic layer having insulation.

4. The sensor as set forth in claim 3, wherein the insulation layer is formed of an oxide magnetic material comprising at least two elements selected from the group consisting of Fe, Ni, Zn, Mn, Mg, Co, Ba, and Sr.

5. The sensor as set forth in claim 1, further comprising a power coil formed on one surface of the magnetic layer.

6. The sensor as set forth in claim 1, further comprising an electromagnetic wave shielding layer formed on the other surface of the magnetic layer.

7. The sensor as set forth in claim 6, wherein the electromagnetic wave shielding layer includes an electromagnetic wave absorbing material and a heat dissipation material.

8. The sensor as set forth in claim 6, wherein the electromagnetic wave shielding layer is adhered to the other surface of the magnetic layer via adhesives.

9. A method of manufacturing a sensor for a digitizer, comprising:
forming a lower magnetic layer having insulation on one surface of a base film;
forming a first coil on one surface of the lower magnetic layer;
forming an upper magnetic layer on one surface of the lower magnetic layer such that the first coil is embedded in the upper magnetic layer;
forming a second coil on one surface of the upper magnetic layer; and
forming an insulating layer on one surface of the upper magnetic layer so as to cover the second coil.

10. The method as set forth in claim 9, further comprising, after the forming of the lower magnetic layer, delaminating the base film from the lower magnetic layer.

11. The method as set forth in claim 10, further comprising, after the delaminating of the base film from the lower magnetic layer, forming an electromagnetic wave shielding layer on the other surface of the lower magnetic layer.

12. The method as set forth in claim 11, wherein the electromagnetic wave shielding layer includes an electromagnetic wave absorbing material and a heat dissipation material.

13. The method as set forth in claim 9, wherein the upper magnetic layer and the lower magnetic layer are formed of an oxide magnetic material comprising at least two elements selected from the group consisting of Fe, Ni, Zn, Mn, Mg, Co, Ba, and Sr.

14. The method as set forth in claim 9, wherein the insulating layer is a magnetic layer having insulation.

15. The method as set forth in claim 14, wherein the insulation layer is formed of an oxide magnetic material comprising at least two elements selected from the group consisting of Fe, Ni, Zn, Mn, Mg, Co, Ba, and Sr.

16. The method as set forth in claim 9, wherein the forming of the second coil includes forming a power coil on one surface of the upper magnetic layer.
